(19) United States
(12) Patent Application Publication
(10) Pub. No.: US 2025/0055154 A1
(43) Pub. Date: Feb. 13, 2025

(54) ELECTRODE ROLL WITH A DISCRETE CONTACT SURFACE, AN ELECTRODE DISC AND A CYLINDRICAL SECONDARY CELL

(71) Applicant: NORTHVOLT AB, Stockholm (SE)

(72) Inventor: Michael SHAUGHNESSY, Västerås (SE)

(21) Appl. No.: 18/788,663

(22) Filed: Jul. 30, 2024

(30) Foreign Application Priority Data
Aug. 11, 2023 (SE) 2350956-5

(51) Int. Cl. H01M 50/533; H01M 50/107; H01M 50/536

(52) U.S. Cl. CPC H01M 50/533; H01M 50/107; H01M 50/536

(57) ABSTRACT

This disclosure presents an electrode roll (10) for a secondary cell (100) comprising a liquid electrolyte, the electrode roll (10) comprising an electrically conductive sheet (1) rolled (1′) along its longitudinal axis (X) to form the electrode roll (10), the electrically conductive sheet (1) comprising a coated portion (2) provided with an electrode coating to form a positive or a negative electrode, and a contact portion (3) protruding from the coated portion (2) and bent (3′) to form an electrical contact surface (11) on a first end surface (13) of the electrode roll (10), wherein the electrical contact surface (11) extends only along a sector (C) of the first end surface (13). An electrode disc (20) is also presented.

### BACKGROUND

### Related Field

The present disclosure generally pertains to secondary cells, and more particularly to an electrode roll, an electrode disc and a cylindrical secondary cell comprising such and electrode roll and/or electrode disc.

### Related Art

In addressing climate change, there is an increasing demand for rechargeable batteries, e.g. to enable electrification of transportation and to supplement renewable energy. Such batteries typically comprise a number of cells, often referred to as secondary cells.

In battery manufacturing it is known in the art to provide an electrically conductive sheet with a coating that is rolled up into a cylinder. In so called tabless cells, the electrically conductive sheet has an uncoated edge protruding on a side of the cylinder. The edge may be folded to provide an electrical contact surface.

As the demand for rechargeable batteries increases, more and more focus is being placed on production speed. To achieve an effective production of rechargeable batteries, the design of the batteries can be optimized.

### BRIEF SUMMARY

It is in view of the above considerations and others that the embodiments of the present invention have been made. The present disclosure aims at providing long life and high performance secondary cells that are efficient in manufacture.

According to a first aspect, the present disclosure provides an electrode roll for a secondary cell comprising a liquid electrolyte, the electrode roll comprising an electrically conductive sheet rolled along its longitudinal axis to form the electrode roll, the electrically conductive sheet comprising a coated portion provided with an electrode coating to form a positive or a negative electrode, and a contact portion protruding from the coated portion and bent to form an electrical contact surface on a first end surface of the electrode roll, wherein the electrical contact surface extends only along a sector of the first end surface.

As the end surface of the cylindrical roll is circular, it will be understood that the term ‘sector’ takes its usual mathematical meaning when discussing circular geometries. Specifically, the term ‘sector’ is intended to mean a portion or part of the circular end surface that is bounded by an arc and its two radii.

As the electrical contact surface extends only along a sector of the first end surface, there is a sector of the first end surface along which the electrical contact surface does not extend. The electrical contact surface extends only along a sector and not along the complete circumference of the first end surface. In other words, the electrical contact surface extends along a part of the circumference of the first end surface. The electrical contact surface may be referred to as a discrete electrical contact surface, or a circumferentially discrete electrical contact surface. The sector may be less than 90 degrees of the 360 degrees circumference of the first end surface, such as less than 60 degrees or less than 30 degrees.

Since the electrical contact surface only forms a part of the first end surface of the electrode roll, there is a remaining part of the first end surface of the electrode roll that is free from an electrical contact surface. In other words, the electrical contact area, provided by the electrical contact surface, forms a part of the end area of the electrode roll. The remaining part, or area, of the first end surface of the electrode roll may be referred to as an electrolyte flow surface, as it readily allows the flow of electrolyte there through.

The electrode roll may be provided with an electrical contact surface of a tailored size, position and form while a sufficient area for flow of electrolyte may be ensured. The bent, or folded, contact portion may form a continuous electrical contact surface.

As is to be apprehended, the electrical contact surface that is formed by folding (in other words bending) the contact portion of the electrically conductive sheet is relatively liquid tight. The liquid electrolyte that is comprised in the secondary cell does not flow easily, or does not flow at all, through the electrical contact surface when the electrolyte is filled into the secondary cell during manufacture. The electrical contact surface shall preferably be relatively liquid tight and flat to provide good electrical contact. During manufacture, the electrical contact surface is typically brought in electrical contact with an electrode disc or a similar component that is in turn in electrical contact with a terminal of the secondary cell. The electrode disc or similar component is typically welded to the electrical contact surface, e.g. by laser welding.

A relatively large electrolyte flow surface is advantageous as it may reduce the time required for filling the secondary cell, and thus the electrode roll, with liquid electrolyte. This shortened time may reduce any oxidation of the coated portion of the electrically conductive sheet, which may increase the performance of the secondary cell. On the other hand, if the electrical contact surface is too small, as a result of the electrolyte flow surface being very large, the electrical resistance of the electrode roll may become undesirably high.

The electrical contact surface may form 10 to 60, preferably 10 to 50 and most preferred 20 to 40 percent of the first end surface of the electrode roll. A larger electrical contact surface facilitates electrically contacting it to an electrode disc or similar component, e.g. by welding. A larger electrical contact surface may also be beneficial for keeping the electrical resistance of the electrode roll low. On the other hand, as mentioned, a larger electrical contact surface hinders electrolyte flow.

The electrical contact surface may extend only along a radial portion of the complete radius of the first end surface. That is, the sector may not extend entirely from a center of the circular end surface to an outer circumference thereof, but the sector may be further bounded between the center an intermediate radius, an intermediate radius and the outer circumference, or between two intermediate radii. Thus, the electrical contact surface may be a discrete electrical contact surface. The electrical contact surface may be discrete both as seen radially and circumferentially (i.e., around the angular co-ordinate). In other words, the electrical contact surface may form an island on the first end surface of the electrode roll.

The radial portion may be less than 90 percent of the radius of the first end surface, such as less than 50 percent or less than 40 percent. The sector may be less than 30 degrees of the circumference of the first end surface and the radial portion may be less than 40 percent of the radius of the first end surface.

The electrode roll may comprise at least two electrical contact surfaces, which may be beneficial since plural electrical contact paths to the terminal of the secondary cell may increase the reliability. The electrode disc or similar component may thus be reliably electrically connected to plural electrical contact surfaces. The separate electrical contact surfaces are preferably circumferentially separate, i.e. arranged at a circumferential distance from one another. In addition, one advantage of providing at least two electrical contact surfaces is that the mechanical stability of a physical contact between the first end surface of the electrode roll and an electrode disc or a similar component may be increased. In particular if there are provided more than two electrical contact surfaces. The first end surface of the electrode roll may be provided with at least two electrical contact surfaces of the same axial height.

The electrode roll may comprise two to six, such as three or four, electrical contact surfaces. The electrical contact surfaces may be circumferentially evenly distributed on the first end surface of the electrode roll.

The electrical contact surface may be elongated, the electrical contact surface comprising a radial extension that exceeds its circumferential extension. In other words, the electrical contact surface may be elongated with its longer axis aligned with the radius of the first end surface of the electrode roll. Such a shape may be beneficial for electrolyte filling, for providing an electrode roll of low electrical resistance, and for forming an electrical connection between the electrical contact surface and an electrode disc or a similar component. The electrical connection may e.g. be formed by laser welding.

The electrical contact surface may be tapered, meaning that the electrical contact surface comprises a wider radial end and a narrower radial end. The narrower radial end may point towards a center of the electrode roll. Such a tapered shape may be beneficial as the radially outer part of the electrode roll may require more current conducting area than the radially inner part of the electrode roll.

The electrically conductive sheet may comprise a plurality of distanced contact portions protruding from the coated portion, the electrically conductive sheet being configured such that the contact portions, after the electrically conductive sheet has been rolled and the contact portions have been bent, are positioned adjacent one another on the first end surface to form a single electrical contact surface. Contact portions of adjacent turns of the electrode roll may overlap one another after the contact portions have been bent. A bent contact portion may be essentially aligned with the first end surface, i.e. be essentially aligned with the first end surface of the electrode roll.

The electrically conductive sheet may comprise a plurality of distanced contact portions protruding from the coated portion, the electrically conductive sheet being configured such that the contact portions, after the electrically conductive sheet has been rolled and the contact portions have been bent, are positioned adjacent one another on the first end surface to form one single or least two separate electrical contact surfaces.

In some detail, the electrically conductive sheet may be configured as regards the number of contact portions protruding from the coated portion, the extension of the contact portions along the longitudinal axis of the electrically conductive sheet, and the distance between the contact portions.

A contact portion may extend to the outer end of the electrically conductive sheet, which outer end is arranged on the outer circumference surface of the electrode roll, such that one electrical contact surface is arranged at or extends to the outer edge of the first end surface of the electrode roll. Such an electrical contact surface may require less radial extension to obtain a desired electrical contact area, as compared to an electrical contact surface arranged at a distance from the outer edge. In addition, an electrical contact surface arranged at the outer edge of the first end surface of the electrode roll may be particularly accessible for electrical contact to e.g. an electrode disc. The outer circumference surface may alternatively be referred to as outer circumferential surface.

Alternatively, no contact portion may extend to the outer end of the electrically conductive sheet, which outer end is arranged on the outer circumference surface of the electrode roll, such that no electrical contact surface is arranged at or extends to the outer edge of the first end surface of the electrode roll. Such a design may be beneficial for electrolyte filling and may reduce the electrical resistance of the electrode roll.

No contact portion may extend to the inner end of the electrically conductive sheet, which inner end is arranged at the center of the electrode roll, such that no electrical contact surface is arranged at the center of the first end surface of the electrode roll. Such a design may be of advantage as it may provide an electrolyte flow surface at the center of the first end surface of the electrode roll, which may be beneficial for electrolyte filling. Such a design may in addition reduce the electrical resistance of the electrode roll.

As a result of the electrode roll being form of a rolled sheet, there may be a cylindrical, e.g. circular cylindrical, though-opening through the center if the electrode roll.

No contact portion may extend to the outer end or to the inner end of the electrically conductive sheet. Thereby, no electrical contact surface will be arranged at the outer edge or at the center of the first end surface of the electrode roll. Such a design may be of advantage as it may provide electrolyte flow surfaces on all sides of the formed electrical contact surface(s).

The electrode roll may comprise a first end electrical contact surface on a first end surface of the electrode roll and a second end electrical contact surface on a second end surface of the electrode roll. The first end electrical contact surface and the second end electrical contact surface may be of the same shape.

Alternatively, the first and second end surfaces may comprise electrical contact surfaces that are not of the same shape and/or dimension. The first end electrical contact surface and the second end electrical contact surface may not fully overlap, or not overlap at all. Such a design may be beneficial for electrolyte flow.

The contact portion is typically uncoated. The contact portion typically comprises a plurality of notches to facilitate folding.

According to a second aspect, the present disclosure provides an electrode disc for a secondary cell comprising an electrode roll and a liquid electrolyte. The electrode roll comprises an end surface a part of which is an electrical contact surface that extends only along a sector of the first end surface. The electrode disc comprises a disc contact portion of a shape that essentially conforms to the electrical contact surface of the electrode roll, and a disc through-opening circumferentially surrounding the disc contact portion, such that the electrode disc may electrically contact the electrical contact surface while allowing electrolyte flow through the electrode disc into the electrode roll.

The electrode disc may be configured to be brought in electrical contact with the above-described electrode roll. The disc contact portion, or disc contact portions, may be essentially adapted to the above-described electrical contact surface, or electrical contact surfaces. Thus, advantages and further possible features of such an electrode disc are similar to the ones mentioned above in connection with the electrode roll. The shapes and dimensions of embodiments of the electrode disc may thus be the same as the shapes and dimension of the of the electrode roll. However, it is to be apprehended that the electrode disc may find use together with an electrode roll different from the one described above.

The electrode disc may comprise a radially outer annulus portion and at least one disc contact portion that extends radially inwards from the radially outer annulus portion. The outer annulus portion may be electrically connected to e.g. an outer can of the secondary cell, e.g. by welding. The secondary cell is typically a cylindrical secondary cell.

According to a third aspect, the present disclosure provides an arrangement comprising the above-described electrode roll and the above-described electrode disc, the disc contact portion of the electrode disc being adapted to be laser welded to the electrical contact surface of the electrode roll.

According to a fourth aspect, the present disclosure provides a cylindrical secondary cell comprising the above-described electrode roll and/or the above-described electrode disc. The cylindrical secondary cell may comprise an outer can of a radius larger than the radius of the electrode roll and an open mandrel around which the electrically conductive sheet is rolled, such that electrolyte flow paths are formed by the space between the outer can and the electrode roll and by the mandrel.

Advantages and further possible features of such a cylindrical secondary cell are similar to the ones mentioned above in connection with the electrode roll.

According to a general aspect, the present disclosure provides an electrode roll for a secondary cell comprising a liquid electrolyte, the electrode roll comprising an electrically conductive sheet rolled along its longitudinal axis to form the electrode roll, an end surface of the electrode roll comprising an electrical contact surface that extends only along a sector of the first end surface. In addition, the electrical contact surface may extend only along a radial portion of the radius of the first end surface. Typically, the electrode roll comprises at least two electrical contact surfaces. Advantages and further possible features of such an electrode roll are similar to the ones mentioned above in connection with the electrode roll of the first aspect.

The above-described electrode rolls, electrode disc, arrangement and cylindrical secondary cell may be for, or comprised in, a vehicle battery for propelling a vehicle. The vehicle may for example be a fully electrically propelled vehicle or a hybrid vehicle.

### BRIEF DESCRIPTION OF THE DRAWINGS

The embodiments disclosed herein are illustrated by way of example, and by not by way of limitation, in the figures of the accompanying drawings. Like reference numerals refer to corresponding parts throughout the drawings, in which:

FIG. 1 is a schematic, exploded view of a first embodiment of an electrode roll and a first embodiment of an electrode disc for a secondary cell,

FIG. 2 illustrates the electrode disc of FIG. 1 welded to the electrode roll, and the electrode roll partly inserted into a can of a cylindrical secondary cell,

FIGS. 3-6 are plan views of electrode discs of various embodiments,

FIG. 7 schematically illustrates an electrically conductive sheet before being rolled to form an electrode roll of FIG. 1,

FIG. 8 shows two electrically conductive sheets and separator sheets being rolled to form an electrode roll of FIG. 1, and

FIG. 9 shows a sheet blank that can be cut to form two conductive sheets of FIG. 8.

### DETAILED DESCRIPTION

Embodiments of the present disclosure will now be described more fully hereinafter. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art.

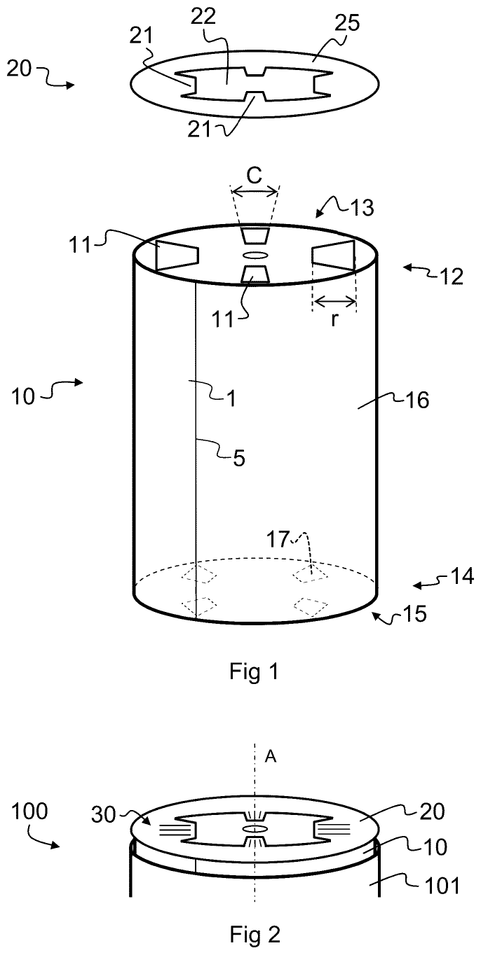

FIG. 1 illustrates a first embodiment of an electrode roll 10, sometimes referred to as a jelly roll, for a secondary cell 100 partly illustrated in FIG. 2. The secondary cell 100 comprises the electrode roll 10, a liquid electrolyte and further components, as will be described below. The electrode roll 10 is of a circular cylindrical shape and extends along a center axis A (FIG. 2) from a first end 12 to a second end 14. The first end 12 (top end in FIG. 1) has a first end surface 13 and the second end 14 has a second end surface 15. The electrode roll 10 further has an outer circumference surface 16.

Referring in particular to FIGS. 1, 2 and 7, the electrode roll 10 comprises an electrically conductive sheet 1 rolled 1′ along its longitudinal axis X to form the electrode roll 10. The electrically conductive sheet 1 comprises a coated portion 2 provided with an electrode coating to form a positive or a negative electrode, and a contact portion 3 protruding from the coated portion 2 and bent 3′ to form an electrical contact surface 11 on a first end surface 13 of the electrode roll 10. The contact portion 3 is thus bent centrally, around an axis being orthogonal to the center axis A and being tangential to a periphery of the first end surface 13. In this way a side surface of the contact portion 3 will extend in a plane transversal to the center axis A to form the electrical contact surface 11, in turn also arranged in a plane transversal to the center axis A. The electrical contact surface 11 extends only within/along a sector C of the first end surface 13. As illustrated, the electrical contact surface 11 may extend only along a radial portion r of the radius of the first end surface 13. Put another way, the electrical contact surface 11 may be bounded by in an angular and a radial portion on the circular end surface 13. The contact surface 11 thus hinges to the periphery of the first end surface 13.

Referring to FIG. 1, the electrical contact surface 11 be seen as an island on the first end surface 13 of the electrode roll 10. In the illustrated embodiment, there are four discrete electrical contact surfaces 11.

FIG. 7 illustrates the electrically conductive sheet 1 that may be rolled 1′ along its longitudinal axis or direction X to form the electrode roll 10 of FIG. 1. The electrically conductive sheet 1 is schematically illustrated in FIG. 7, it is to be apprehended that, for illustrative purposes, the length of the electrically conductive sheet 1 along its longitudinal axis X is very understated in relation to its height (transverse the longitudinal axis X). After the electrically conductive sheet 1 has been rolled 1′ to form the electrode roll 10, the longitudinal axis X is aligned with a plane that it orthogonal to the center axis A of the electrode roll 10.

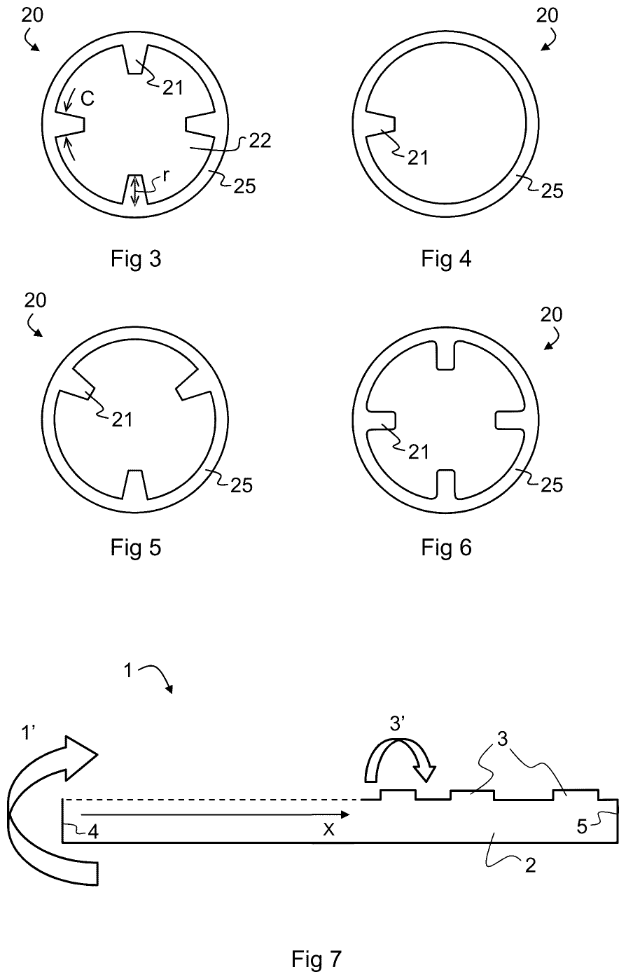

As is indicated in FIG. 7, the electrically conductive sheet 1 comprises the coated portion 2 provided with at least one electrode coating to form a positive or a negative electrode, and the plurality of contact portions 3 protruding from the coated portion 2 and bent 3′, or folded, to form an electrical contact surface 11 at the first end surface 13 of the electrode roll 10. In other words, the conductive sheet 1 comprises contact portions 3 arranged along an end side (upper side in FIG. 3), or longitudinal end side, of the conductive sheet 1. The contact portions 3 are typically free of coating. The electrical contact surface 11 that is formed by the contact portions 3 may alternatively be referred to as a bent contact portion.

Even though it is in principle possible to form an electrode roll 10 of an electrically conductive sheet 1 that comprises only one contact portion 3, there will typically be a plurality of contact portions 3. In the schematic illustration of FIG. 7, three contact portions 3.

Furthermore, even though it is in principle possible that the electrode roll 10 may comprise only one electrical contact surface 11, there will typically be a plurality of electrical contact surface 11. In the embodiment of FIG. 1, there are four discrete electrical contact surfaces 11.

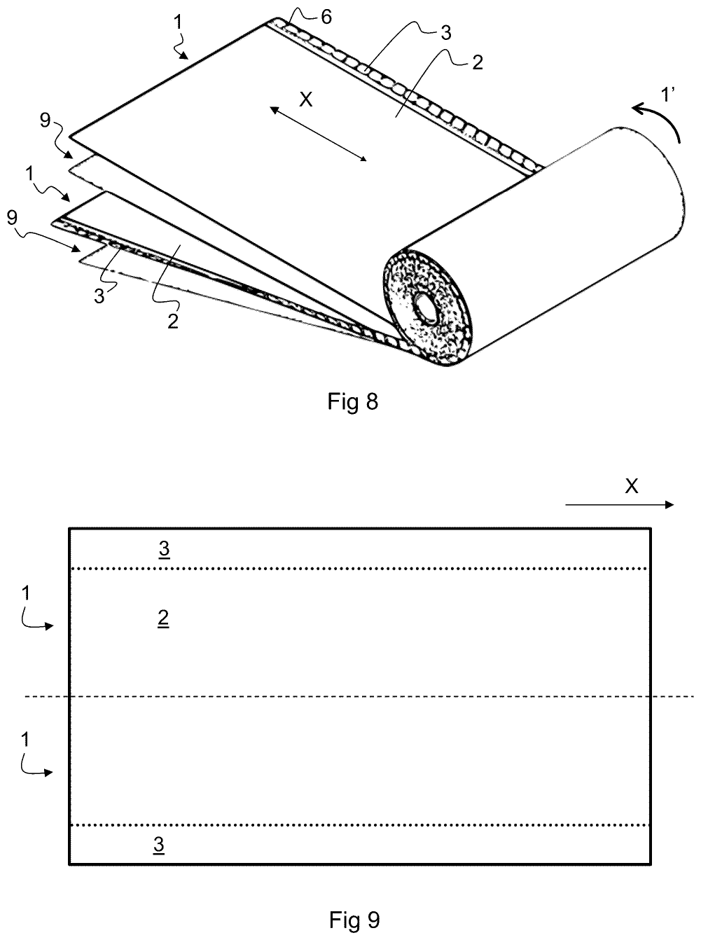

As is explained with reference to FIGS. 8 and 9 below, the electrode roll typically comprises a number of electrically conductive sheets and separators, but the focus of the present disclosure is on the electrical contact surface 11 of the electrode roll 10 formed by the electrically conductive sheet 1.

As is shown in FIG. 7, the contact portions 3 do not extend along the entire length (along the longitudinal direction X) of the electrically conductive sheet 1. In other words, the contact portions 3 extends along a part or section of the length of the electrically conductive sheet 1. Thus, the contact portions 3 of the electrically conductive sheet 1 are shorter than the coated portion 2 of the electrically conductive sheet 1. Typically, the contact portions 3 do not extend to the inner end 4 of the electrically conductive sheet 1. Thus, the electrical contact surface 11 is arranged at a radial distance from the center of the electrode roll 10.

In the first embodiment of the electrode roll 10, the contact portion 3 does not extend to the outer end 5 of the electrically conductive sheet 1, as is illustrated in FIG. 7. The conductive sheet 1 has the shape of a rectangle with two long sides and two short sides. When rolled 1′, one short side end 4 will be arranged in the center of the roll 10 and the opposing short side end 5 will be arranged at the circumferential surface 16 of the electrode roll 10. The short side end 5 that will be arranged at the circumferential surface 16 of the electrode roll 10 is thus referred to as the outer end 5 of the electrically conductive sheet 1.

Some further components of a secondary cell, which are known per se, will now be explained with reference to FIGS. 8 and 9. FIG. 8 shows an isometric view of a general electrode roll of a cylindrical secondary cell. The electrode roll normally consists of a first electrically conductive sheet 1 and a second electrically conductive sheet 1, both sheets 1 with respective electrode coating on a coated portion 2. The two electrically conductive sheets 1 are arranged with separator sheets 9 in between and rolled to an electrode roll. The electrode roll is shown in a state during the rolling 1′ of the conductive sheets 1 and the separators 9. In the electrode roll of a cylindrical secondary cell, the coating on one of the electrically conductive sheets 1 is a positive electrode and the coating of the other electrically conductive sheet is the negative electrode of the secondary cell.

An electrically conductive sheet 1 with a coated portion 2 provided with coating forming a positive electrode may for example be made of aluminium (aluminum in US English). A conductive sheet 1 with a coated portion 2 provided with coating forming a negative electrode may for example be made of copper. The conductive sheets 1 comprise one or more coatings, forming electrode coatings. Typically, notches 6 are cut, or otherwise formed, into the longitudinal side edges of the conductive sheets 1. Even though not illustrated in FIG. 7, there are notches 6 formed in the contact portions 3 of the electrically conductive sheet 1. The notches 6 forms flaps which can be bent 3′ inwards towards the longitudinal axis A after the different stacked layers of the electrode roll are rolled up. The bending of the notches 6 of the contact portion 3 to form the electrical contact surface 11 is illustrated by a curved arrow 3′ in FIG. 7.

The electrode roll 10 is subsequently arranged in a can 101, or outer can or enclosure, with terminals and parts connecting the electrical contact surfaces 11 of the electrode roll to terminals to form the cylindrical secondary cell 100. The cylindrical secondary cell 100 may also include one or more vents and insulating parts. Persons skilled in the art are aware of various designs of these parts, and they will not be described herein.

FIG. 9 shows a sheet blank that can be cut to form two electrically conductive sheets 1, 1. Two electrically conductive sheets are here produced from one sheet blank which is cut in half (along the dotted central line) to form two separate electrically conductive sheets 1, 1. The electrically conductive sheets are then provided as a coiled or rolled up continuous material on which a series of manufacturing steps are carried out, such as coating, rolling, pressing, heat treatment etc. These manufacturing steps are known per se, and not descried in detail herein. It is possible to form the notches 6 at any state of the manufacturing process. The dotted lines indicate the coated portion 2 where the electrode coating is to be arranged on the conductive sheet. In other words, the electrode coating is to be arranged between the two dotted lines.

As is illustrated in FIG. 1, the electrical contact surfaces 11 of the first end surface 13 of the electrode roll 10 may not overlap the electrical contact surfaces 17 of the second end surface 15 of the electrode roll 10. For example, as shown, the first end electrical contact surfaces 11 may be circumferentially offset from the second end electrical contact surfaces 17. Alternatively, the first and second end electrical contact surfaces 11, 17 may be of different shapes and/or dimensions.

FIGS. 1 and 3 shows a first embodiment of an electrode disc 20 for a secondary cell. The electrode disc 20 may be brought in electrical contact, e.g. direct physical contact, with the above-described electrical contact surface(s) 11 of the electrode roll 10 of the first embodiment. The electrode disc 20 is in typically addition brought in electrical contact with a terminal of the secondary cell, typically via at least one further electrically conductive component. The electrode disc 20 may be brought in electrical contact, e.g. direct physical contact, e.g. by welding, with the outer can 101 of the secondary cell 100. A portion of the outer surface of the outer can 101 may form a terminal (typically the negative terminal) of the secondary cell 100.

Typically, when used together with the above-described electrical contact surface 11 of the electrode roll 10 of the first embodiment, the electrode disc 20 is essentially of the same shape and dimensions as the electrical contact surface 11.

The electrode disc 20 of FIGS. 1 and 3 (first embodiment) comprises a disc contact portion 21 of a shape that essentially conforms to the electrical contact surface 11 of the electrode roll 10 of the first embodiment (FIG. 1), and a disc through-opening 22 circumferentially surrounding the disc contact portion 21. Thus, the electrode disc 20 may electrically contact the electrical contact surfaces 11 while allowing electrolyte flow through the electrode disc 20 into the electrode roll 10. In more detail, the electrode disc 20 of FIGS. 1 and 3 comprises a radially outer annulus portion 25 and four disc contact portions 21 that extend radially inwards from the radially outer annulus portion 25. The radially outer annulus portion 25 and the disc contact portions 21 are formed in one piece.

The electrode discs 20 of the other three embodiment, shown in FIGS. 4 to 6, also comprise at least one disc contact portion 21 of a shape that essentially conforms to the electrical contact surface of undepicted corresponding electrode rolls, and a disc through-opening 22 circumferentially surrounding the disc contact portion 21.

The electrode disc 20 of FIG. 4 (second embodiment) comprises a radially outer annulus portion 25 and one disc contact portion 21 that extends radially inwards from the radially outer annulus portion 25. The disc contact portion 21 is elongated and tapered.

The electrode disc 20 of FIG. 5 (third embodiment) comprises a radially outer annulus portion 25 and three disc contact portions 21 that extends radially inwards from the radially outer annulus portion 25. The disc contact portions 21 are elongated and tapered.

The electrode disc 20 of FIG. 6 (fourth embodiment) comprises a radially outer annulus portion 25 and four disc contact portions 21 that extends radially inwards from the radially outer annulus portion 25. The disc contact portions 21 are elongated and rectangular.

Referring to FIGS. 1 to 3, 5 and 6, the disc contact portions 21 of the electrode disc, and thus the corresponding electrical contact surfaces of the electrode roll, may be circumferentially evenly distributed. However, it will be appreciated that an uneven distribution can also be implemented.

As may be apprehended from FIG. 2, the radially outer annulus portion 25 may electrically connect the disc contact portions 21 to the outer can 101 of the cylindrical secondary cell 100. FIG. 2 further illustrates how the disc contact portions 21 of the electrode disc 20 of the may be welded to the electrical contact surfaces 11 of the electrode roll 10. There may be three laser weld lines 30 arranged along the disc contact portions 21 and the electrical contact surfaces 11. The material and the thickness of the disc contact portions 21 may be selected such that the laser welding may be performed though the disc contact portions 21 when the electrode disc 20 is placed on, and optionally pressed towards, the first end surface 13 of the electrode roll 10.

It will be appreciated that the annulus portion is optional for connecting the disc contact portions 21. Indeed, the electrode ‘disc’ may not be disc-shaped at all. Instead, the electrode disc may take any suitable shape, and preferably one that conforms to the shape(s) of the disc contact portion(s) 21 and allows for their connection to the can 101 or to a terminal assembly. Further, the annulus portion may not be arranged at a radially outer portion of the end surface, but may instead be at a radially central portion, or at some intermediate location. Moreover, the annulus may not be annular but may instead be polygonal or the like.

The electrical contact surfaces 11 (and the disc contact portions 21) may be elongated. The laser weld lines 30 may be aligned with the extension, i.e. longer side, of the elongated electrical contact surfaces 11. The laser weld lines 30 may be arranged in parallel with one another, referring to FIGS. 1 to 5, the electrical contact surfaces 11 (and the disc contact portions 21) may taper towards the electrode roll center.

It is to be noted that the reference sign 21 is used for the disc contact portions of all embodiments. Instead, the disc contact portions of the first embodiment may be denoted 21a, the disc contact portions the second embodiment may be denoted 21b, the disc contact portions the third embodiment may be denoted 21c and the disc contact portions the second embodiment may be denoted 21d. Similarly, the corresponding electrical contact surfaces of the electrode roll embodiments may be denoted 11a, 11b, 11c and 11d.

Modifications and other variants of the described embodiments will come to mind to ones skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure.

Furthermore, although specific terms may be employed herein, they are used in a generic and descriptive sense only and not for purposes of limitation. Therefore, persons skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims (or embodiments), these may possibly advantageously be combined, and the inclusion of different claims (or embodiments) does not imply that a certain combination of features is not feasible and/or advantageous. In addition, singular references do not exclude a plurality. Finally, reference numerals in the claims are provided merely as a clarifying example and should not be construed as limiting the scope of the claims in any way.

1-20. (canceled)

21. An electrode roll (10) for a secondary cell (100) comprising a liquid electrolyte, the electrode roll (10) comprising an electrically conductive sheet (1) rolled (1′) along its longitudinal axis (X) to form the electrode roll (10), the electrically conductive sheet (1) comprising:
a coated portion (2) provided with an electrode coating to form a positive or a negative electrode, and
a contact portion (3) protruding from the coated portion (2) and bent (3′) to form an electrical contact surface (11) on a first circular end surface (13) of the electrode roll (10),
wherein the electrical contact surface (11) extends only along a sector (C) of the first circular end surface (13).

22. The electrode roll (10) of claim 21, wherein the central angle of the sector (C) is less than 90 degrees.

23. The electrode roll (10) of claim 21, wherein the electrical contact surface (11) extends only along a radial portion (r) of the radius of the first end surface (13).

24. The electrode roll (10) of claim 23, wherein the radial portion (r) is less than 90 percent of the radius of the first end surface (13).

25. The electrode roll (10) of claim 21, wherein the central angle of the sector (C) is less than 30 degrees and the radial portion (r) is less than 40 percent of the radius of the first end surface (13).

26. The electrode roll (10) of claim 21, wherein the electrical contact surface (11) comprises at least two electrical contact surfaces (11).

27. The electrode roll (10) of claim 21, wherein the electrical contact surface (11) comprises two to six electrical contact surfaces (11).

28. The electrode roll (10) of claim 21, wherein the electrical contact surface (11) forms 10 to 60 percent of the end surface (13) of the electrode roll (10).

29. The electrode roll (10) of claim 21, wherein the electrical contact surface (11) is elongated, the electrical contact surface (11) comprising a radial extension (r) that exceeds its angular extension (C).

30. The electrode roll (10) of claim 29, wherein the electrical contact surface (11) is tapered, the electrical contact surface (11) comprising a wider radial end and a narrower radial end, the narrower radial end pointing towards a center of the electrode roll (10).

31. The electrode roll (10) of claim 21, wherein the electrically conductive sheet (1) comprises a plurality of distanced contact portions (3) protruding from the coated portion (2), the electrically conductive sheet (1) being configured such that the contact portions (3), after the electrically conductive sheet (1) has been rolled (1′) and the contact portions (3) have been bent (3′), are positioned adjacent one another on the first end surface (13) to form an electrical contact surface (11).

32. The electrode roll (10) of claim 21, further comprising a second end surface (15) comprising a second end electrical contact surface (17).

33. The electrode roll (10) of claim 32, wherein the first and second end surfaces (13, 15) comprise electrical contact surfaces (11, 17) that are not of the same shape and/or dimension.

34. The electrode roll (10) of claim 32, wherein the electrical contact surface (11) of the first end surface (13) does not fully overlap the second end electrical contact surface (17) of the second end surface (15).

35. An electrode disc (20) for a secondary cell (100) comprising an electrode roll (10) and a liquid electrolyte, the electrode roll (10) comprising a circular end surface (13), a part of which is an electrical contact surface (11) that extends only along a sector (C) of the circular end surface (13), wherein the electrode disc (20) comprises a disc contact portion (21) of a shape that essentially conforms to the electrical contact surface (11) of the electrode roll (10), and a disc through-opening (22) at least partially surrounding the disc contact portion (21), such that the electrode disc (20) may electrically contact the electrical contact surface (11) while allowing electrolyte flow through the electrode disc (20) into the electrode roll (10).

36. The electrode disc (20) of claim 35 comprising a radially outer annulus portion (25) and at least one disc contact portion (21) that extends radially inwards from the radially outer annulus portion (25).

37. The electrode disc (20) of claim 35 comprising a radially outer annulus portion (25) and two to six disc contact portions (21) that extend radially inwards from the radially outer annulus portion (25).

38. An arrangement comprising:
the electrode roll (10) of claim 21; and
an electrode disc (20) comprising an electrode roll (10) and a liquid electrolyte, the electrode roll (10) comprising a circular end surface (13), a part of which is an electrical contact surface (11) that extends only along a sector (C) of the circular end surface (13), wherein the electrode disc (20) comprises a disc contact portion (21) of a shape that essentially conforms to the electrical contact surface (11) of the electrode roll (10), and a disc through-opening (22) at least partially surrounding the disc contact portion (21), such that the electrode disc (20) may electrically contact the electrical contact surface (11) while allowing electrolyte flow through the electrode disc (20) into the electrode roll (10),
wherein the disc contact portion (21) of the electrode disc (20) is configured to be laser welded (30) to the electrical contact surface (11) of the electrode roll (10).

39. The arrangement of claim 38, wherein the disc contact portion (21) of the electrode disc (20) and the electrical contact surface (11) of the electrode roll (10) are elongated, the disc contact portion (21) is welded to the electrical contact surface (11), and at least one laser weld line (30) is aligned with the extensions of the disc contact portion (21) and the electrical contact surface (11).

40. A cylindrical secondary cell (100) comprising at least one of:
an electrode roll (10) comprising an electrically conductive sheet (1) rolled (1′) along its longitudinal axis (X) to form the electrode roll (10), the electrically conductive sheet (1) comprising: a coated portion (2) provided with an electrode coating to form a positive or a negative electrode, and a contact portion (3) protruding from the coated portion (2) and bent (3′) to form an electrical contact surface (11) on a first circular end surface (13) of the electrode roll (10), wherein the electrical contact surface (11) extends only along a sector (C) of the first circular end surface (13); or
an electrode disc (20) comprising an electrode roll (10) and a liquid electrolyte, the electrode roll (10) comprising a circular end surface (13), a part of which is an electrical contact surface (11) that extends only along a sector (C) of the circular end surface (13), wherein the electrode disc (20) comprises a disc contact portion (21) of a shape that essentially conforms to the electrical contact surface (11) of the electrode roll (10), and a disc through-opening (22) at least partially surrounding the disc contact portion (21), such that the electrode disc (20) may electrically contact the electrical contact surface (11) while allowing electrolyte flow through the electrode disc (20) into the electrode roll (10).
